(19) United States
(12) Patent Application Publication
(10) Pub. No.: US 2007/0271575 A1
(43) Pub. Date: Nov. 22, 2007

(54) Disk Drive Unit

(75) Inventor: Kum Chung Loh, Singapore (SG)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/574,532

(22) PCT Filed: Aug. 26, 2005
(86) PCT No.: PCT/IB05/52800

§ 371 Date: Mar. 1, 2007

(30) Foreign Application Priority Data
Sep. 2, 2004 (EP) 04104201.1

(51) Int. Cl. G11B 17/025

(52) U.S. Cl. 720/695; 369/271.1

(57) ABSTRACT

A disk drive unit for a disk (D), comprises a turntable (2) for a disk (D) which is rotatably supported by the base and drivable by a motor (6) including a stator (7) mounted on the base and a rotor (5) connected to the turntable. A clamping mechanism (9, 11) is provided to hold the disk firmly on the turntable. A suction mechanism (9, 10) effects an axial attraction force between the stator and the rotor. The clamping and suction mechanisms (9, 10, 11) include a single annular magnet (9) attached to the turntable (2) on a side thereof facing the stator (7). As a result, the magnet is protected against corrosion and foreign particles and there is no need for a back yoke to create sufficient attraction force. This leads to an easily balanced turntable which can be produced in a cost-effective manner.

### FIELD OF THE INVENTION

The invention relates to a disk drive unit for a disk to be used in a device for reading and/or writing the disk. The unit comprises a turntable adapted to support a disk thereon, a clamping mechanism to hold the disk firmly on the turntable, and a suction mechanism to effect an axial attraction force between the stator and the rotor of the turntable drive motor. The clamping and suction mechanisms include magnet means connected to the turntable.

### BACKGROUND OF THE INVENTION

A disk drive unit of the type described above is known from JP 2003-299302. In a first embodiment thereof, the turntable comprises an annular clamp magnet fixed to the turntable from the upper side through a back yoke. This clamp magnet and back yoke serve as clamping and suction mechanism. In a second embodiment, there are provided four cylindrical magnets extending vertically through the turntable and being distributed around the rotary axis of the turntable in order to perform the same functions.

It is an object of the present invention to provide an improved disk drive unit.

### SUMMARY OF THE INVENTION

In a first aspect of the invention, the disk drive unit is constructed in accordance with the features of claim 1. In this unit the required magnetic forces are obtained in an efficient manner. Preferably, the common magnet is attached to the turntable on a side thereof facing the stator. Due to the placement of the common magnet on the side of the turntable facing the stator, the magnet is protected against corrosion and foreign particles. Furthermore, it is possible to create sufficient attraction force for the clamping and suction functions without the need of a back yoke in the turntable.

In the embodiment according to claim 3, the integration of the magnet within the turntable contributes to the stiffness of the turntable, in particularly if the feature of claim 4 is present as well.

This embodiment enables the feature of claim 6, as the integration of the stiff magnet in the turntable allows minimizing the thickness of the plastic turntable at the position of the magnet without sacrificing the wobble accuracy of the turntable. This small wall thickness reduces the air gap between the magnet and any damper structure on the other side of the turntable and the desired clamping force can be obtained by varying the thickness of the turntable wall at the position of the magnet.

In a further aspect of the invention, the disk drive has the features of claim 11. This arrangement of the single magnet may lead to an easily balanced turntable in which efficient use is made of the single magnet, without requiring a back yoke. This enables a cheaper production of the turntable.

These and other aspects of the invention will be apparent from and elucidated with reference to the embodiment(s) described hereinafter.

### BRIEF DESCRIPTION OF THE DRAWINGS

FIG. 1 is a vertical cross section of a half of the disk drive unit according to one embodiment of the invention.

FIG. 2 is an exploded side view of the embodiment of the disk drive unit according to the invention as shown in FIG. 1.

### DETAILED DESCRIPTION OF PREFERRED EMBODIMENTS

The drawings show an embodiment of a disk drive unit. This disk drive unit may be used in a device for reading and/or writing data from or on a disk D, such as an optical disk or the like. The device in which this disk drive unit is used may be a portable or a stationary device, such as an audio or video player and/or recorder or a data disk reader and/or writer.

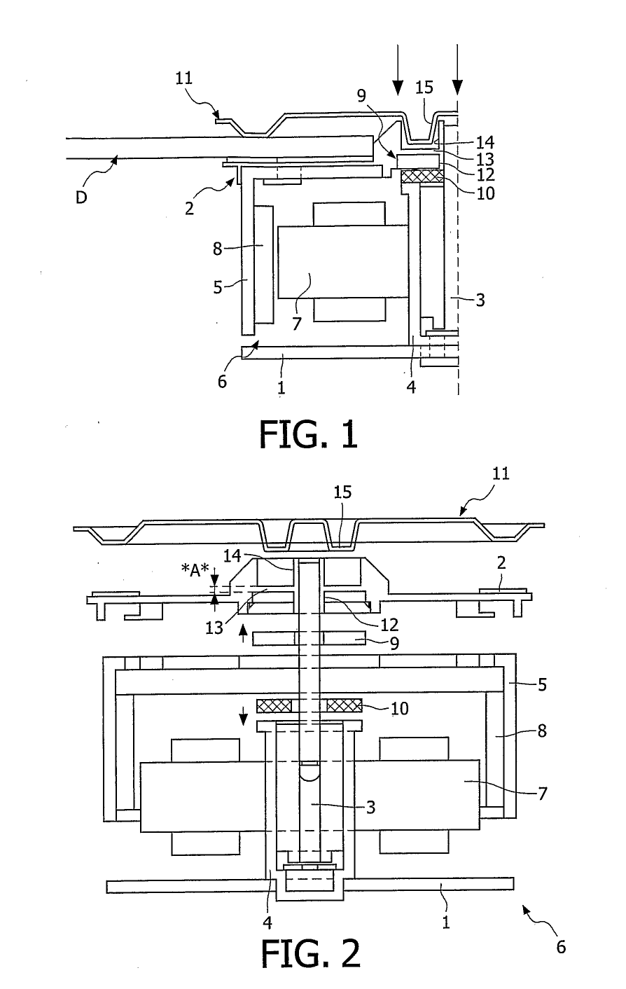

As shown in FIGS. 1 and 2, the disk drive unit includes a base 1 to support the disk drive unit. This base 1 carries a turntable 2 which is rotatably supported by the base 1 through a rotary spindle 3 which is rotatably mounted in a bearing column 4 of the base 1. The turntable 2 is preferably made of plastic and is attached to the free end of the rotary spindle 3. Attached to the lower side of the turntable 2 is a rotor 5 which forms part of an electric motor 6. The stator 7 of this electric motor is attached to the column 4 of the base 1 and includes coils distributed around the axis of the rotary spindle 3. The rotor 5 includes rotor magnets 8 co-operating with the electric coils of the stator 7 to obtain a drive torque.

According to the invention, there is fixed a magnet 9 to the turntable 2, preferably integrated therein. This magnet 9 co-operates with a metal yoke 10 arranged on top of the bearing column 4 of the stator 7 in order to obtain an axial attraction force between the rotor 5 and the stator 7 to reduce the rotor vibration in axial direction. In this way, the magnet 9 is part of a so-called suction mechanism.

Additionally, the magnet 9 performs a clamping function in co-operation with a magnetizable, metal damper 11 positioned on the disk D which is positioned on the turntable 2 in order to firmly clamp this disk D down on the turntable in order to stabilize this disk D during rotation of the turntable.

As is shown in the drawings, in particular FIG. 2, the magnet 9 has an annular shape with the axis of the magnet 9 coinciding with the axis of the rotary spindle 3. The inner and outer circumferences of the annular magnet 9 are circular and the cross-section of the magnet is preferably rectangular in which the thickness is smaller than the width. The magnet 9 is attached to the turntable 2 on the side thereof which faces the stator 7. For this purpose, the turntable 2 comprises a first annular recess 12 shaped complementary to the magnet 9 so that the magnet 9 tightly fits into this recess 12. The magnet 9 is fixed to the turntable 2 by means of adhesive or the like provided on the three sides of the magnet which are in contact with the turntable 2 so that the magnet 9 forms part of the structure of the turntable and adds to the stiffness thereof.

On the side of the magnet 9 facing away from the stator 7, the turntable 2 shows only a thin radial wall 13 which is left between the first recess 12 and a second recess 14 on the opposite side of the turntable 2. This recess 14 is more or less axially aligned with the first recess 12 and is adapted to receive an annular projection 15 of the damper 11 to enable the metal damper 11 to be arranged in close proximity to the magnet 9. This is done in order to obtain a sufficient attraction force for clamping the damper 11 on the disk D. To obtain this, the thickness A of the thin wall 13 is for example as small as ca. 0.2-0.5 mm depending on the type of magnet used and the clamping force which is required. In the clamping position, there is only a small spacing left between the top of the annular projection 15 and the bottom of the recess 14 in the turntable 2. The recess 14 is made in the hub section of the turntable which projects through a disk D when this disk is positioned on the turntable.

Due to the integration of the magnet 9 in the turntable 2, there is no need for a back yoke and the turntable may be kept thin at the position of the magnet without sacrificing the wobble accuracy of the turntable 2. By using a common magnet for the clamping mechanism and the suction mechanism there is obtained a reduction of the B.O.M. in the spindle motor. Mounting the single magnet to the turntable by means of adhesive directly to the plastic turntable is easy. The magnetic circuit can be more efficient due to the position of the magnet between the damper 11 and the metal stator yoke 10 forming a closed magnetic circuit. As the volume of the magnet 9 is larger than with two separate magnets, the attraction force between the stator and the rotor will be much higher. This will ease up the design tolerances and assembly of the motor.

In the presently preferred embodiments, the disk D is an optical data disk. However, it should be understood that the invention can also be used for all kinds of disks, e.g. ferro-electric, magnetic, magneto-optic, optical, near-field, active charge storage disks or other disks using combinations of these techniques or other reading and/or writing techniques.

It is noted that in specification and claims, the use of the expressions “a” or “an” does not exclude a plurality thereof, whereas the expression “comprising” does no exclude additional elements or steps. Any reference signs in the claims shall not be construed as limiting the scope thereof A single processor or unit may fulfil the functions of several elements in the appended claims.

The invention is not restricted to the above-described embodiment as shown in the drawing, which can be varied in several ways without departing from the scope of the appended claims. For example, the position and shape of the magnet may be varied. Moreover, various combinations of features described in the claims are possible within the scope of the invention.

1. A disk drive unit for a disk (D) to be used in a device for reading and/or writing the disk, comprising:
a base (1);
a turntable (2) adapted to support a disk (D) thereon and rotatably supported by the base and drivable by a motor (6) including a stator (7) mounted on the base and a rotor (5) connected to the turntable, the rotor and stator including magnet (8) and coil members to effect a driving moment on the turntable;
a clamping mechanism (9, 11) to hold the disk firmly on the turntable, and a suction mechanism (9, 10) to effect an axial attraction force between the stator and the rotor, the clamping and suction mechanisms (9, 10, 11) including a common magnet (9) attached to the turntable (2).

2. A disk drive unit according to claim 1, wherein the common magnet (9) is attached to a side of the turntable (2) which side faces the stator (7).

3. A disk drive unit according to claim 1, wherein the magnet (9) is annular and is provided in a first annular recess (12) in the turntable (2).

4. A disk drive unit according to claim 1, wherein the magnet (9) is attached to the turntable (2) at least on its outer circumference, and preferably on all of its sides which are in contact with the turntable.

5. A disk drive unit according to claim 1, wherein the magnet (9) is attached to the turntable (2) by means of adhesive.

6. A disk drive unit according to claim 4, wherein the turntable (2) is provided with a second annular recess (14) in the side of the turntable facing away from the stator (7), said second annular recess being axially aligned at least partly with the first annular recess (12), leaving a thin radial wall (13) of the turntable between the first and second recesses (12, 14).

7. A disk drive unit according to claim 6, wherein the thickness of the thin wall (13) is ca. 0.2-0.5 mm.

8. A disk drive unit according to claim 6, comprising a magnetizable clamper (11) adapted to be provided on a side of the disk (D) facing away from the turntable (2), said clamper including an annular projection (15) on its side facing the disk when positioned thereon, said annular projection being adapted to project through a central opening in the disk and into the second annular recess (14), such that only a small spacing is left between the annular projection (15) and a bottom of the second annular recess (14).

9. A disk drive unit according to claim 1, wherein the turntable (2) is provided with a closed wall (13) at the position of the magnet (9).

10. A disk drive unit according to claim 1, wherein the magnet (9) is positioned completely within the turntable (2).

11. A disk drive unit for a disk (D) to be used in a device for reading and/or writing the disk, comprising:
a base (1);
a turntable (2) adapted to support a disk (D) thereon and being rotatably supported by the base;
a motor (6) for driving the turntable, said motor including a stator (7) mounted on the base and a rotor (5) connected to the turntable, the rotor and stator including magnet (8) and coil members to effect a driving moment on the turntable;
a clamping mechanism (9, 11) to hold the disk firmly on the turntable, said clamping mechanism including magnet means (9) connected to the turntable,
a suction mechanism (9, 10) to effect an axial attraction force between the stator and the rotor, the suction mechanism including magnet means (9) connected to the turntable,
wherein said magnet means (9) of the suction and clamping mechanisms consists of a single annular magnet attached directly to the plastic turntable (2) and extending concentrically around the axis of rotation of the turntable.

12. A disk drive unit according to claim 11, wherein the magnet (9) is attached to the side of the turntable (2) facing the stator (7).

13. A device comprising the disk drive unit according to claim 1 and a reading and/or writing unit.
